(19) United States
(12) Patent Application Publication
(10) Pub. No.: US 2019/0029190 A1
(43) Pub. Date: Jan. 31, 2019

(54) SHIELD FOR PROTECTING PLANTS

(71) Applicant: Fruit Shield, Inc., Los Angeles, CA (US)

(72) Inventor: Samir Fawzi Masri, Los Angeles, CA (US)

(21) Appl. No.: 16/151,216

(22) Filed: Oct. 3, 2018

Related U.S. Application Data
(63) Continuation-in-part of application No. 15/165,480, filed on May 26, 2016, now abandoned.

(51) Int. Cl. A01G 13/04; A01G 13/02; A01G 13/10

(52) U.S. Cl. CPC A01G 13/043; A01G 13/10; A01G 13/0231

(57) ABSTRACT

A shield for protecting a plant, the shield having: a shield assembly apparatus having: a top apparatus portion; a base apparatus portion having a base center tube extending upwards from a floor; an interior space formed by an association of the top apparatus portion with the base apparatus portion; support stick holes in a circular arrangement along an outer edge; grooves within the interior space; wherein each groove is supported by walls, and extends from a support stick hole to the base center tube, and is sloped such that the walls are taller when meeting the base center tube than when meeting the support stick hole; such that the shield assembly apparatus is capable of supporting frame components within the grooves; and wherein the shield is capable of shielding and protecting the plant without any portion of the shield being supported by the plant.

### CROSS-REFERENCE TO RELATED APPLICATIONS

This application is a continuation-in-part of and claims the benefit of U.S. Non-Provisional application Ser. No. 15/165,480, filed May 26, 2016, which is hereby incorporated by reference, to the extent that it is not conflicting with the present application.

### BACKGROUND OF INVENTION

### 1. Field of the Invention

The invention relates generally to agriculture and more specifically to the protection of crops, trees, and other plants from pests and weather.

### 2. Description of the Related Art

Growers of fruit trees, vegetables, and other crops or plants often suffer from the loss of some of their crops due to inclement weather and/or pests. Maintenance of such crops and other plants must include protection of the crops from insects, birds, and harmful weather such as frost, hail, heavy rainfall, and heavy winds. Pollination control is also a control for growers of crops. Pesticides and other such chemicals used to combat this loss may also end up harming the plants, or may be considered to be undesirable by some users who wish to grow their grows more organically. Greenhouses may be used to give the crops some protection, but these greenhouses requires a high amount of labor to install and build, and the greenhouses may not be suitable for smaller batches of crops, and are not practical for users who only wish to protect a small amount of plants. The greenhouses may also not be suitable for temporary use, due to the high amount of labor needed for the installation and the takedown. The greenhouses may also be expensive or cost-prohibitive for the user, particularly if materials such as metals are used in the construction of the greenhouse. Some methods known in the art for protecting crops from insects and harmful weather such as frost include netting, but some types of netting may make contact with the crops that they are set up to protect, and this can cause damage to the crops, particularly if the netting weighs down on the crops. This may also stunt the growth of the crops, and can thus be detrimental to the crops.

Thus, there is a need for a product that reduces the use of chemicals for growing crops, while still providing protection for the crops from bugs, birds, and other pests, in a cost-effective way.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an aspect a shield is provided having a frame, combined with a cover supported by the frame and used to cover fruit trees, crops, and other plants without touching the plants. The shield protects the plants from pests and heavy weather such as frost, wind, or hail. An advantage is that costs and labor are reduced by eliminating the use of greenhouses. Another advantage is that the use of pesticides is reduced by physically blocking pests from the plants, which may reduce contamination of water by pesticides, and the increase the availability of organic crops. Another advantage is that fewer bees and other insects will be killed by the reduction in pesticide use, while pollination control is also provided for the user, giving the user the ability to keep bees and other pollinators in or out of the cover as needed.

In another aspect, a breathable and durable cover is provided that is combinable with a frame, and expandable in size by the user by attaching a plurality of pieces together. An advantage is that anything may be protected according to the needs of the user, by adding several covers together and customizing the size of the cover.

In another aspect, a shield for protecting a plant is provided, the shield comprising: a shield assembly apparatus having: a top apparatus portion having an upper top apparatus portion end, a bottom top apparatus portion end, and a first center hole passing through the top apparatus portion; a base apparatus portion configured to be associated with the top apparatus portion, the base apparatus portion having a floor, an upper base apparatus portion end, a bottom base apparatus portion end, a base center tube extending upwards from the floor, a second center hole passing through the base center tube and through the base apparatus portion; an interior space formed by an association of the top apparatus portion with the base apparatus portion; an outer edge having a rounded shape; a plurality of support stick holes in a circular arrangement along the outer edge; a plurality of grooves within the interior space; wherein each groove of the plurality of grooves is supported by walls extending upwards from the floor; wherein each groove of the plurality of grooves extends from a support stick hole of the plurality of support stick holes to the base center tube; wherein each groove of the plurality of grooves is sloped such that the walls are taller when meeting the base center tube than when meeting a support stick hole of the plurality of support stick holes; such that the shield assembly apparatus is capable of supporting frame components within the plurality of grooves; and wherein the shield is capable of shielding and protecting the plant without any portion of the shield being supported by the plant. Thus, again, an advantage is that costs and labor are reduced by eliminating the use of greenhouses, when a cover is used with the shield having the shield assembly apparatus. Another advantage is that the use of pesticides is reduced by physically blocking pests from the plants, which may reduce contamination of water by pesticides, and the increase the availability of organic crops. Another advantage is that fewer bees and other insects will be killed by the reduction in pesticide use, while pollination control is also provided for the user, giving the user the ability to keep bees and other pollinators in or out of the cover as needed. Another advantage is that the user can customize the size and shape of the shield, and thus protect a variety of sizes and shapes of plants and other crops. Another advantage is that the shields can easily and efficiently be combined such that a large plant or a large group of plants may be protected by the shield or shields.

In another aspect, a shield for protecting a plant is provided, the shield comprising: a frame, and a cover supported by the frame; the frame having: a stem having an upper stem end and a bottom stem end; a plurality of support sticks; and a shield assembly apparatus having: a top apparatus portion having an upper top apparatus portion end, a bottom top apparatus portion end, and a first center hole passing through the top apparatus portion; a base apparatus portion configured to be associated with the top apparatus portion, the base apparatus portion having a floor, an upper base apparatus portion end, a bottom base apparatus portion end, a base center tube extending upwards from the floor, a second center hole passing through the base center tube and through the base apparatus portion, and a stem receiving tube on the bottom base apparatus portion end configured to receive the upper stem end; an interior space formed by an association of the top apparatus portion with the base apparatus portion; an outer edge having a rounded shape; a plurality of support stick holes in a circular arrangement along the outer edge; a plurality of grooves within the interior space; wherein each groove of the plurality of grooves is supported by walls extending upwards from the floor; wherein each groove of the plurality of grooves extends from a support stick hole of the plurality of support stick holes to the base center tube; wherein each groove of the plurality of grooves is sloped such that the walls are taller when meeting the base center tube than when meeting a support stick hole of the plurality of support stick holes; wherein each support stick of the plurality of support sticks can be inserted into the support stick hole of the plurality of support stick holes, and next inserted into and held in place by a groove of the plurality of grooves; wherein the shield assembly apparatus is capable of supporting the plurality of support sticks within the plurality of grooves such that the plurality of support sticks forms a platform support structure for the cover in which the entire first plurality of sticks or a portion thereof extends in a circular arrangement above the plant; and wherein the shield is capable of shielding and protecting the plant without any portion of the shield being supported by the plant. Thus, again, an advantage is that costs and labor are reduced by eliminating the use of greenhouses. Another advantage is that the use of pesticides is reduced by physically blocking pests from the plants, which may reduce contamination of water by pesticides, and the increase the availability of organic crops. Another advantage is that fewer bees and other insects will be killed by the reduction in pesticide use, while pollination control is also provided for the user, giving the user the ability to keep bees and other pollinators in or out of the cover as needed. Another advantage is that a user may easily and quickly disassemble the shield as needed, by removing the cover and leaving the frame in place when the user determines that the barrier provided by the cover is not needed, and the cover can easily and quickly be replaced when the protection is again needed. Another advantage is that the user can customize the size and shape of the shield, and thus protect a variety of sizes and shapes of plants and other crops. Another advantage is that the shields can easily and efficiently be combined such that a large plant or a large group of plants may be protected by the shield or shields.

In another aspect, a method of providing protection to a plant using a shield is provided, the shield comprising: a frame, and a cover supported by the frame; the frame having: a stem having an upper stem end and a bottom stem end; a plurality of support sticks; and a shield assembly apparatus configured to be associated with the stem by having a hollow tube for receiving the upper stem end; the shield assembly apparatus having: a top apparatus portion having an upper top apparatus portion end, a bottom top apparatus portion end, and a first center hole passing through the top apparatus portion; a base apparatus portion configured to be associated with the top apparatus portion, the base apparatus portion having a floor, an upper base apparatus portion end, a bottom base apparatus portion end, a base center tube extending upwards from the floor, a second center hole passing through the base center tube and through the base apparatus portion, and a stem receiving tube on the bottom base apparatus portion end; an interior space formed by an association of the top apparatus portion with the base apparatus portion; an outer edge having a rounded shape; a plurality of support stick holes in a circular arrangement along the outer edge; a plurality of grooves within the interior space; wherein each groove of the plurality of grooves is supported by walls extending upwards from the floor; wherein each groove of the plurality of grooves extends from a support stick hole of the plurality of support stick holes to the base center tube; wherein each groove of the plurality of grooves is sloped such that the walls are taller when meeting the base center tube than when meeting a support stick hole of the plurality of support stick holes; wherein each support stick of the plurality of support sticks can be inserted into the support stick hole of the plurality of support stick holes, and next inserted into and held in place by a groove of the plurality of grooves; wherein the shield assembly apparatus is capable of supporting the plurality of support sticks within the plurality of grooves such that the plurality of support sticks forms a platform support structure for the cover in which the entire first plurality of sticks or a portion thereof extends in a circular arrangement above the plant; and wherein the shield is capable of shielding and protecting the plant without any portion of the shield being supported by the plant; the method comprising the steps of: providing the shield assembly apparatus in a disassembled state; creating the frame by inserting each support stick of the plurality of support sticks into each support stick hole of the plurality of support stick holes; securing each support stick of the plurality of support sticks by inserting each support stick into each groove of the plurality of grooves; securing the top shield assembly apparatus portion to the base shield assembly apparatus portion to provide the shield assembly apparatus in an assembled state; associating the stem with the shield assembly apparatus by inserting the top stem end into the stem receiving tube; anchoring the bottom stem end around the plant; placing the cover on top of the platform support structure; removing the cover when a user determines the protection is not needed, while the frame remains in the soil; and replacing the cover when the user determines the protection is needed. Thus, again, an advantage is that costs and labor are reduced by eliminating the use of greenhouses. Another advantage is that the use of pesticides is reduced by physically blocking pests from the plants, which may reduce contamination of water by pesticides, and the increase the availability of organic crops. Another advantage is that fewer bees and other insects will be killed by the reduction in pesticide use, while pollination control is also provided for the user, giving the user the ability to keep bees and other pollinators in or out of the cover as needed. Another advantage is that a user may easily and quickly disassemble the shield as needed, by removing the cover and leaving the frame in place when the user determines that the barrier provided by the cover is not needed, and the cover can easily and quickly be replaced when the protection is again needed. Another advantage is that the user can customize the size and shape of the shield, and thus protect a variety of sizes and shapes of plants and other crops. Another advantage is that the shields can easily and efficiently be combined such that a large plant or a large group of plants may be protected by the shield or shields.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1 shows a top perspective view of exemplary shields, each shield having a frame and a cover, for protection of trees, according to an aspect.

FIG. 2A illustrates a side view of the frame that may support the cover of a shield, according to an aspect.

FIG. 2B illustrates a side view of pads that may be placed at an upper end of the stem of the frame, according to an aspect.

FIG. 3 shows a side view of a frame that may be installed on a fruit tree, according to an aspect.

FIG. 4 shows a side view of an exemplary shield installed over a fruit tree, the shield having a cover supported by a frame protecting the tree, according to an aspect.

FIGS. 5A-5B show the top perspective view and the front view, respectively, of a post 509 that may support a frame of the shield, according to an aspect.

FIG. 5C shows a top perspective view of the post, placed upright into the soil, according to an aspect.

FIG. 6A shows the side perspective view of a shield assembly apparatus provided as a two-piece cap, in an assembled state, according to an aspect.

FIGS. 6B-6D show the top perspective view, the bottom perspective view, and the top perspective exploded view, respectively, of a shield assembly apparatus in an assembled state with inserted support sticks, according to an aspect.

FIGS. 7A-7D show the top perspective view, the top plan view, the bottom plan view, and the side elevation view, respectively, of the base portion of a shield assembly apparatus, according to an aspect.

FIGS. 8A-8D show the top perspective view, the top plan view, the bottom plan view, and the side elevation view, respectively, of the top portion of the shield assembly apparatus, according to an aspect.

FIGS. 9A-9B show top perspective views of examples of an exemplary shield assembly apparatus having apparatus holes, according to an aspect.

FIGS. 10A-10B show the top perspective view and the front perspective view, respectively, of a frame with an exemplary shield assembly apparatus having wire loops, according to an aspect.

FIG. 10C shows the bottom perspective view of a frame with an exemplary shield assembly apparatus, according to an aspect.

FIGS. 11A-11B show the top perspective views of a shield system in a garden, and a shield system alone, respectively, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

For the following description, it can be assumed that most correspondingly labeled elements across the figures (e.g., 206 and 306, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

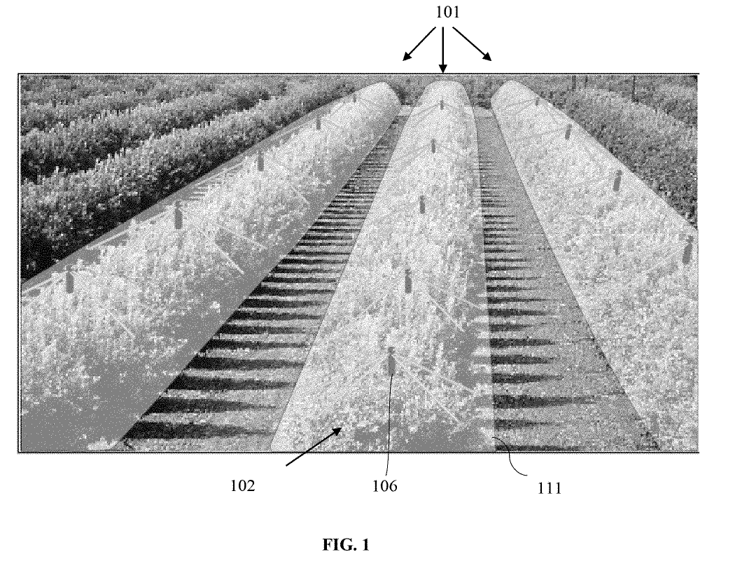

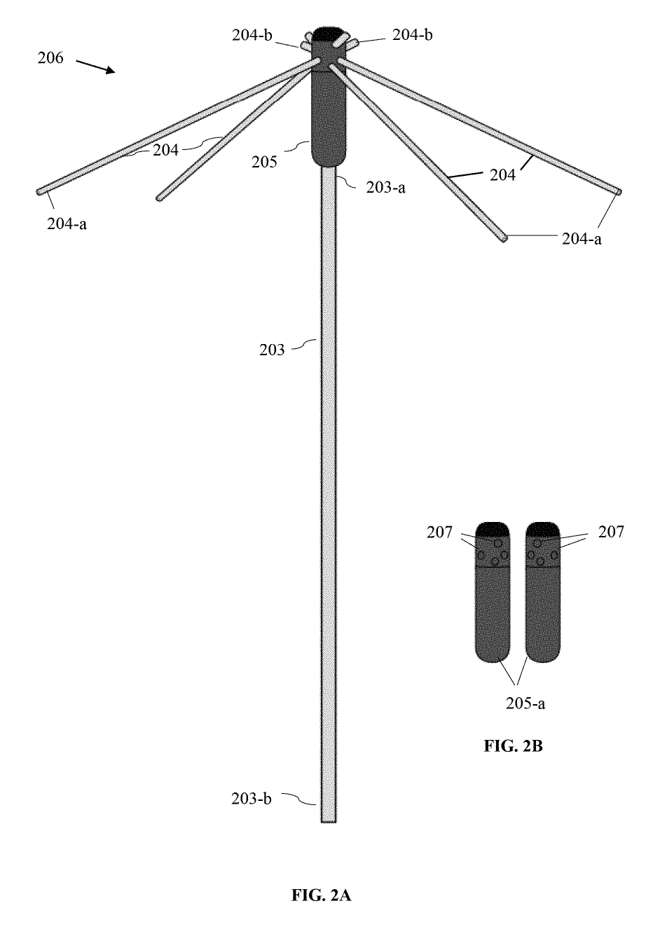

FIG. 1 shows a top perspective view of exemplary shields 101 (“shield,” “fruit shield,” “plant shield,” or “crop shield”), each shield 101 having a frame 106 and a cover 111 (“cover,” “net” or “netting”), for protection of trees 102, according to an aspect. The frame (as shown in FIG. 2) may be a support structure having a stem (as shown by 203 in FIG. 2) and other components such as a shield assembly apparatus (described in further detail herein). The shield 101 may be used to spread the cover 111 over crops or any other type of plant, such that the cover 111 is not supported or held up by the plant itself. The cover may be constructed from cloth, may be woven, and may be a mesh material, such as a net. The mesh may be fine enough to prevent insects, bugs, and other pests from reaching the crops, while still providing protection to the plants. The cover 111 may also help to retain moisture inside of the shielded area for the benefit of the crops being protected. The cover 111 may also be a non-woven material such as, for example, plastic. As an example, the cover may be constructed of polyethylene. An advantage of the cover 111 being constructed from polyethylene is that it may provide the shield 101 with increased durability, and the cover may last for more than 4 years under outdoor weather conditions. The polyethylene may be breathable, and may be constructed in a tight or loose weave, depending on the needs of the user. The frame 106 may be provided in a variety of shapes and sizes in order to accommodate various different needs of the user, and to protect a wide variety of plants and crops, for example.

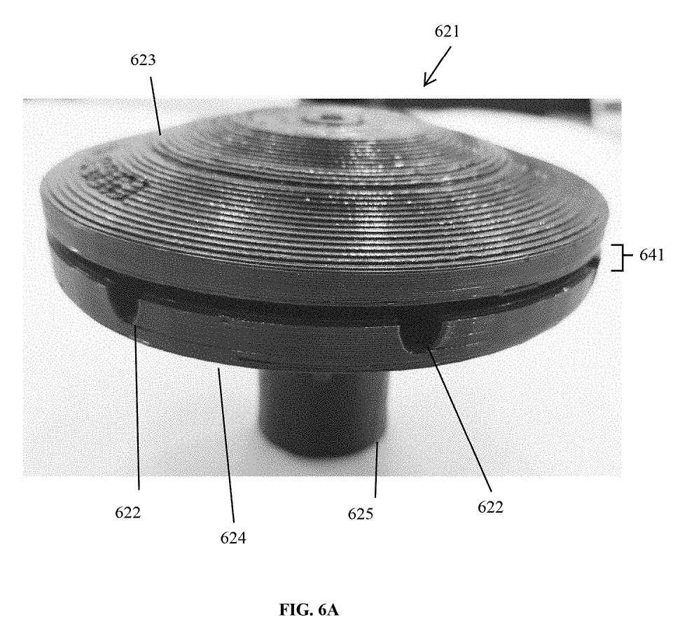

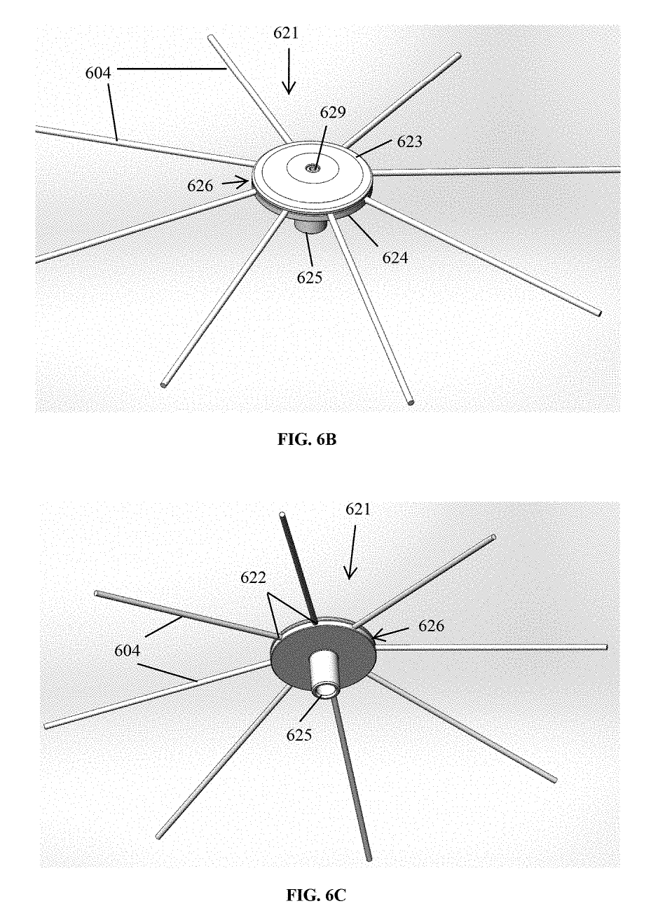

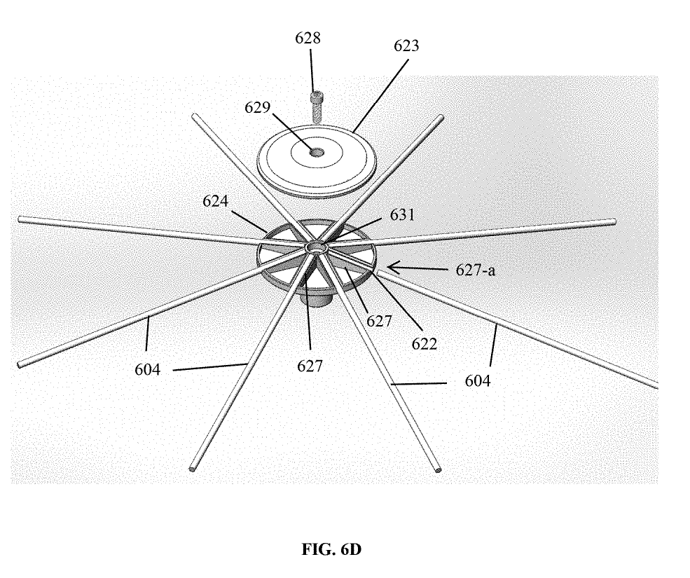

FIG. 2A illustrates a side view of the frame 206 that may support the cover (as shown by 111 in FIG. 1) of a shield (as shown by 101 in FIG. 1), according to an aspect. Exemplary frame components are shown in FIG. 2A. The frame 206 may have a stem (“stem,” or “pole”) 203, support sticks 204 (“sticks” or “support sticks”), and a shield assembly apparatus 205. The shield assembly apparatus 205 may be in any suitable shape or size, and may provided in a variety of shapes and sizes to accommodate differently-sized shields for suitable protection for different types of plants, for example. As shown as an example in FIGS. 2A-2B, the shield assembly apparatus 205 may be cylindrical. The shield assembly apparatus 205 may also be provided in other shapes as will be described further when referring to FIGS. 6A-11.

The stem 203 may have a top end (“top end,” or “upper end”) 203-a at which the shield assembly apparatus 205 is associated, and the stem 203 may have a bottom end (“bottom end” or “lower end”) 203-b which may be inserted into or secured to the ground. The height of the stem 203 may be adjustable, such as, for example, by being available in a variety of sizes, or as another example, may be adjusted by the user by being telescopic. The lower end 203-b of the stem 203 may be blunt as shown, or may be pointed to facilitate inserting the stem 203 into the soil.

Again, as shown as an example in FIG. 2B, the shield assembly apparatuses 205 may be provided as substantially tubular or cylindrical soft pads (“pads”) 205-a (as shown in detail in FIG. 2B), through which the support sticks 204 can be inserted by the user. A pad 205-a or any other shield assembly apparatus 205 for receiving the support sticks 204 and providing structure to the shield frame 206 may be placed on an upper end 203-a of the stem 203. The shield assembly apparatus 205 may be constructed from rubber, which may allow the securing of the support sticks 204 through friction-based insertion. The support sticks 204 may have a distal end 204-a and a proximal end 204-b, and may be inserted into the pad 205 by the proximal end 204-b. The support sticks 204 may be rigid for holding and supporting a cover, and may be constructed from fiberglass. An advantage is that the fiberglass material may be resistant to rusting or cracking.

FIG. 2B illustrates a side view of pads 205-a that may be placed at an upper end 203-a of the stem 203 of the frame 206, according to an aspect. The pads 205-a may be soft and may allow insertion of support sticks 204, and may function as holders for the support sticks 204. The pads 205-a may have a plurality of holes 207 through which the support sticks 204 may be placed by the user, as shown in FIG. 2A. The user may insert as many support sticks 204 as are determined to be needed into the pads 205-a, to create a circular arrangement for a cover to be supported on. The holes 207 may be distributed all around the pad 205-a, along 360 degrees around the pad 205-a, and may be oriented at various angles in relation to the horizontal plane with respect to the bottom end of the shield, such that the user may customize the angle of the support sticks 204. This may be performed by inserting the proximal end 204-b of the support sticks 204 at a desired or predetermined angle with respect to a horizontal plane such as the ground or bottom end of the shield into the pad 205-a. As an example, the support sticks 204 may be inserted into the pad 205-a at a 45 degree angle in relation to the horizontal plane, such that the distal ends 204-a of the support sticks 204 are pointed towards the lower end 203-b of the stem 203. As another example, the support sticks 204 may be inserted into the pad 205 at a 90 degree angle with relation to the horizontal plane, such that the circular arrangement of support sticks 204 is parallel to the horizontal plane. The support sticks 204 may be placed and arranged by the user in any suitable way such that the cover does not interfere with the growth of the plant, and does not rest on the plant itself. The support sticks 204 may also be in varying lengths to accommodate the size of the plant. The cover may then conform to the shape and size of the plant when laid over the support sticks 204 to protect the trees or other crops, while maintaining a predetermined shape over the trees or crops such that the trees or crops are not weighed down by the shield.

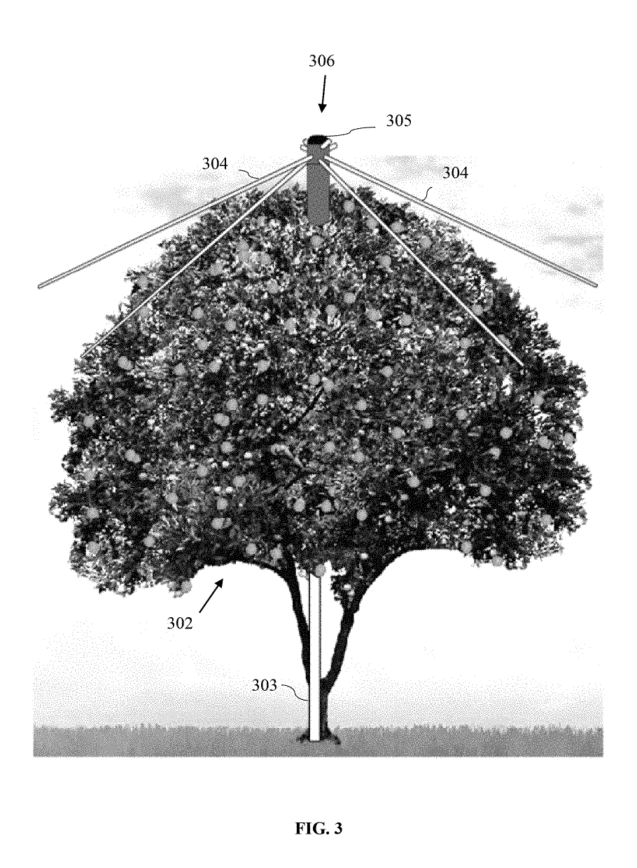

FIG. 3 shows a side view of a frame 306 that may be installed on a fruit tree 302, according to an aspect. For visual clarity, the frame 306 is shown without a cover in FIG. 3. The stem 303 may be held in place by securing it directly into the ground, such as by inserting the stem 303 into the ground or by bolting the stem 303 into place by any suitable means. The stem 303 may then be held upright near or against the trunk of the tree 302. The stem 303 may extend above the tree 302, such that the pad 305 and support sticks 304 that are inserted into the pad 305 fan out above the tree 302, and such that the cover (not shown), and the support sticks 304 do not make substantial contact with the tree 302.

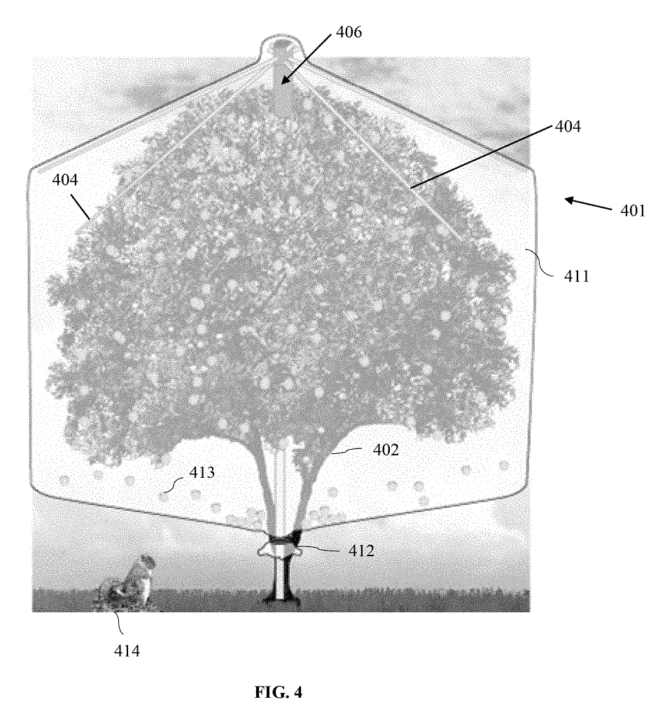

FIG. 4 shows a side view of an exemplary shield 401 installed over a fruit tree 402, the shield 401 having a cover 411 supported by a frame 406 protecting the tree 402, according to an aspect. The shield 401 may be tied together at a point 412 above ground level, such that fruit 413 that naturally falls off of the tree 402 may be caught by the cover 411 without touching the ground. An advantage is that the fruit 413 may be protected from the reach of pests 414 on the ground. Another advantage is that the cover may prevent the pests 414 from climbing into the tree 402 or any other type of plants being protected by the shield 401.

As another example, the cover 411 may also be held in place by weighing it down at the corners or bottom edges by soil or sand bags, pinning it to the ground, or by using any other suitable anchoring means. As another example, the edges of the cover 411 may be provided with a securing means such that the cover 411 can be joined with additional covers 411. The securing means or means for attachment may be, for example, Velcro, a zipper, and so on. The cover may thus be extended by combining a plurality of covers together, and the size may be customized by the user by attaching several covers together, as will be further described hereinafter.

An advantage may be that the size and shape of the cover 411 can be customized to fit the user's needs. It should also be understood that the support sticks 404 may be substantially rigid in order to support the cover 411, but may also be constructed to be flexible such that the support sticks 404 may curve over an area, if needed.

If ventilation or less coverage is needed, the user may loosen the cover 411, such as by untying the cover at the region indicated by 412, or by lifting the cover from an anchoring means used to secure the cover 411 to the ground. For example, more ventilation may be desired in the summer, and a user may provide more air for the plants without disassembly of the entire shield. An advantage may be that adjusting the level of protection provided by the shield 401 may be quick, efficient, and convenient for the user, without the need for the removal of the entire shield 401 from around the plant being protected.

It should be understood that the systems and methods described herein may be used for other applications. As an example, the shield may be used to create other structures, such as, for example, tents for camping or for the beach, protection for outdoor food, baby play pens, and so on. The cover may also be extended by joining pieces together to protect, for example, a swimming pool or spa, and so on, to prevent leaves or other debris from falling into the water, and prevent insects from getting into the water. The cover, when used to protect a swimming pool or spa, may be breathable such that the sunlight may still shine through the cover. The cover may durable and maintain its color through such outdoor use. As another example, the cover may be used to protect a user's body when using a sleeping bag that does not cover the whole body. The user may use any sleeping bag or similar item, and then may cover and protect their entire body by wrapping a cover around their body and the sleeping bag and enclosing both their body and the sleeping bag entirely. The head of the user may then be protected by the cover from, for example, insects or other pests. As another example, the full-body protection of the cover may be used by users in war zones where a sleeping bag, again, may not cover the entire body.

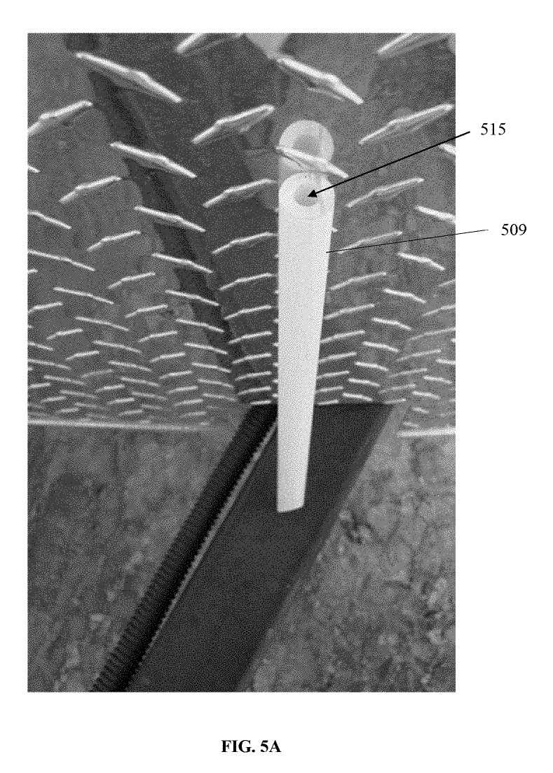

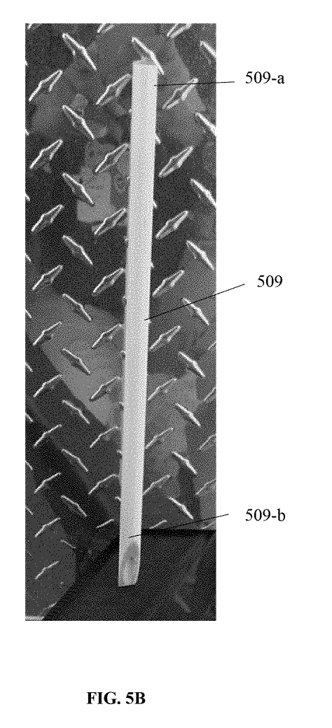

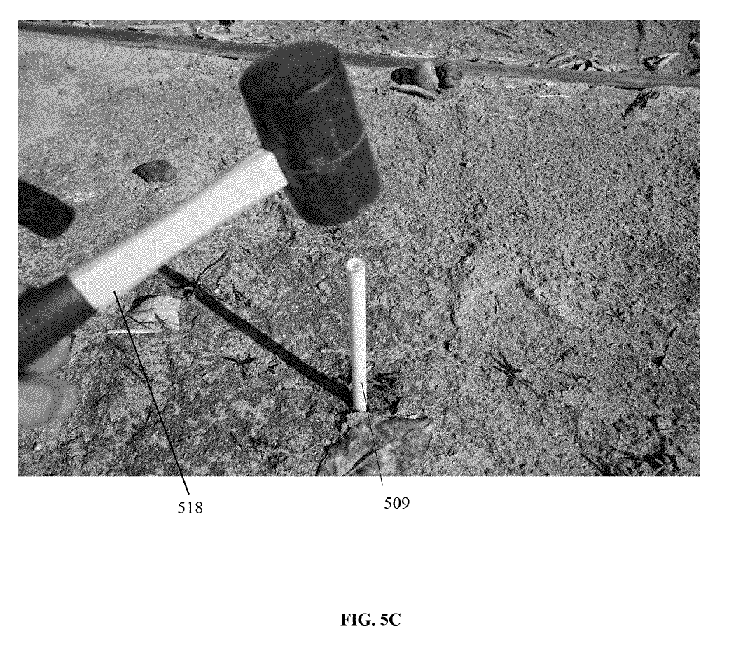

FIGS. 5A-5B show the top perspective view and the front view, respectively, of a post 509 that may support a frame of the shield, according to an aspect. As shown in FIG. 5A, the post 509 may be hollow, as indicated by the open and hollow shaft (“hollow shaft” or “shaft”) 515, according to an aspect. A stem (as shown by 203 in FIG. 2A) may be placed inside of the hollow shaft 515 of the post 509. As another example, the stem may be used without a post 509. Again, the post 509 may be stiff or rigid, such that the post can remain upright when placed in the soil. As shown in FIG. 5B, the lower end 509-b of the post 509 may be pointed for facilitating the driving of the post 509 into the soil. The upper end 509-a of the post 509 may be flat or blunt, as shown. An advantage may be that the safety of the user may be increased when connecting components of the shield together, such as when inserting a stem (as shown by 203 in FIG. 2) into the post 509. Another advantage may be that the height of the stem may be adjusted by using the post 509. For example, a stem may be increased in height by inserting the stem into a post 509.

FIG. 5C shows a top perspective view of the post 509, placed upright into the soil, according to an aspect. The post 509 may be secured by, for example, hammering it with the lower end (as shown by 509-b in FIG. 5B) inserted into the soil. A hammer 518 or any other suitable tool may be used for driving the post 509 into the soil or ground, for example. As another example, the post 509 may be secured to the ground by any other anchoring means. Once all posts 509 of the shield are placed into the soil alongside the crops to be protected, the frame (as shown in FIG. 2A) and a cover (as shown by 411 in FIG. 4) may be assembled to create the shield. The frame and the cover may be easily and quickly removed if the protection is no longer needed or if crops are to be harvested, while the posts 509 may remain in the soil. An advantage may be that the user may easily re-assemble a new shield by using the posts already present in the soil for protecting crops whenever protection is determined to be needed. Another advantage may be that the disassembly of the shield may be faster and more efficient when the posts 509 do not need to be removed.

FIG. 6A shows the side perspective view of a shield assembly apparatus provided as a two-piece cap (“shield assembly apparatus,” “cap,” “two-piece cap,” “shield assembly apparatus cap,” or “apparatus”) 621, in an assembled state, according to an aspect. The shield assembly apparatus 621 may be used in association with a shield for protecting plants, for example. The shield assembly apparatus 621 may be used for supporting the shield, or for construction of a multi-part frame. The shield assembly apparatus 621 may also function as a support for the support sticks (as shown by 204 in FIG. 2A), and may be provided with a plurality of support stick holes (“support stick holes” or “stick holes”) 622 for the insertion of the support sticks (again, as shown by 204 in FIG. 2A). The shield assembly apparatus 621 may be substantially disk-shaped and may have a bottom stem receiving tube (“bottom stem portion,” “stem receiving portion,” “bottom stem receiving portion,” “stem receiving tube,” or “stem receiving shaft”) 625 provided at the bottom side of the apparatus 621. The bottom stem receiving tube 625 may be a hollow tube configured to receive and hold a stem (as shown by 203 in FIG. 2A) of a shield, and may hold the stem by friction, for example, or any other suitable securing means.

The shield assembly apparatus 621 may, for example, be comprised of two portions: a top shield assembly apparatus portion (“top shield assembly apparatus portion,” “top support portion,” “top cap portion,” or “top portion”) 1523 and a bottom portion (“bottom shield assembly apparatus portion,” “base shield assembly apparatus portion,” “bottom portion” “bottom cap portion,” or “base portion”) 1524, for example. The top portion 623 and the base portion 624 may be joined together by the user, or may be provided as a single integral unit. The support holes 622 may be formed along the seam between the top portion 623 and the base portion 624, for example, and the support holes 622 may be situated along an outer edge 626 of the cap 621, or along the seam formed between the top portion 623 and the base portion 624. A space 641 may be provided between the top portion 623 and the base portion 624 when the two portions are joined together.

As an example, a securing means (as shown by 628 in FIG. 6D) may be used to secure together the top shield assembly apparatus portion 623 with the base shield assembly apparatus portion 624. An association of the top portion 623 with the base portion 624 may, again, create a space 641 between the top portion 623 and the base portion 624, or the top portion 623 and the base portion 624 may be associated together with a seam having substantially no space in between. The securing means 628 may be capable of adjusting the space 641 between the top shield assembly apparatus portion 623 and the base shield assembly apparatus portion 624 via a tightening or a loosening of the securing means, which may cause the size of the plurality of support stick holes 622 to be adjusted. As an example, the securing means 628 may be loosened such that the top portion 623 and the base portion 624 remain secured together, but with a larger space 641 in between the portions, allowing a large support stick (as shown by 604 in FIGS. 6B-6C) to be inserted into the enlarged support stick hole 622. As another example, the securing means 628 may be tightened such that the top portion 623 and the base portion 624 remain secured together and close together, or with substantially no space between the portions, creating smaller support stick holes 622. Next, a smaller support stick (as shown by 604 in FIGS. 6B-6C) may be snugly secured into the smaller support stick holes 622. Thus, a variety of sizes of support stick holes 622 may be customized within the shield assembly apparatus 621. Exemplary diameters of support sticks are 4 mm to 6 mm. An advantage may thus be that a single shield assembly apparatus or a plurality of shield assembly apparatuses being of the same type may be used for a variety of needs as determined by the user. As an example, thicker support sticks may be capable of supporting heavier or larger covers for a larger area or larger plants, while smaller or thinner support sticks may be used for protecting smaller areas of plants.

FIGS. 6B-6D show the top perspective view, the bottom perspective view, and the top perspective exploded view, respectively, of a shield assembly apparatus 621 in an assembled state with inserted support sticks 604, according to an aspect. As described when referring to FIG. 6A, the support sticks 604 for holding a cover (not shown) may be inserted into the support stick holes 622 that are positioned along the outer edge 626 of the shield assembly apparatus 621. As an example, eight support stick holes 622 may be provided, and the eight support sticks 604 that are inserted into the shield assembly apparatus 621 may radiate outwards from the shield assembly apparatus 621. The shield assembly apparatus 621 may thus be used with a shield for protecting plants and provide a supportive anchoring means for the support sticks 604 that hold up a cover, for example.

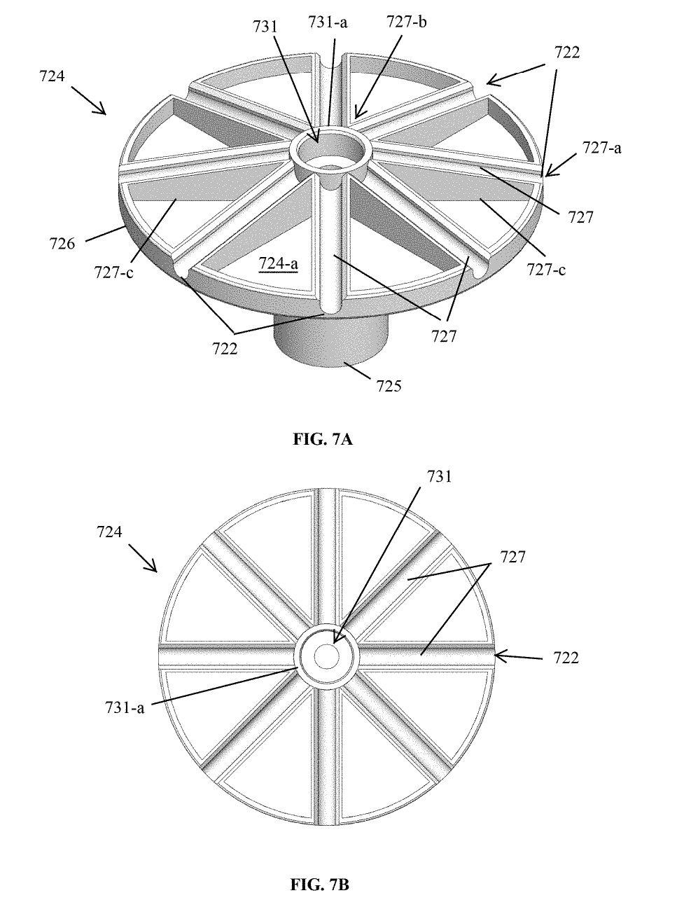

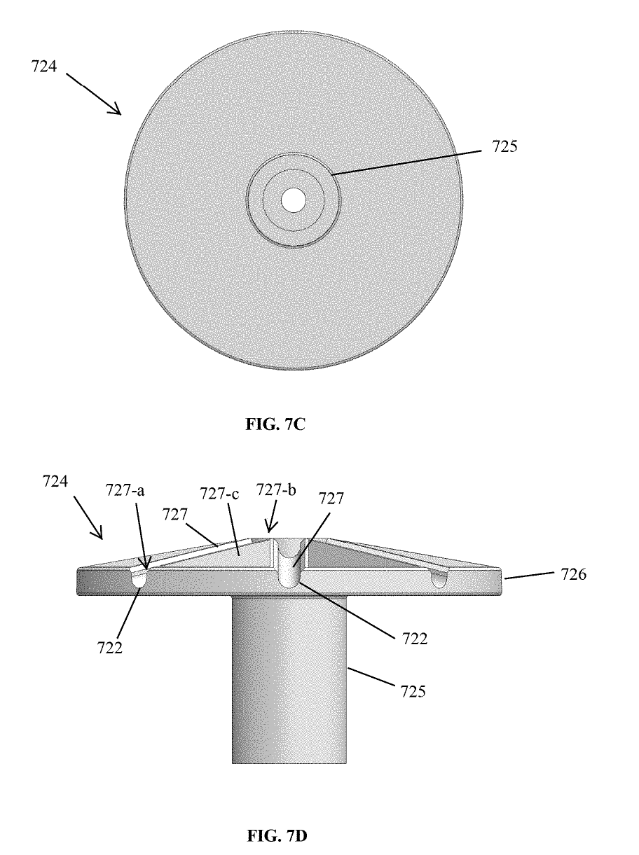

Again, the shield assembly apparatus 621 may be provided in the assembled state by securing together the top portion 623 with the base portion 624. This may be accomplished by using a securing means 628 such as a screw, which may be inserted through a first center hole (“first center hole” or “first securing hole”) 629 of the top portion 623, and next through a second center hole (“second center hole” or “second securing hole”) 631 of the base portion 624 (discussed further herein when referring to FIG. 7A).

As shown in FIG. 6D, the interior space of the shield assembly apparatus 621 may be configured to hold each support stick 604 in place by being provided with the following exemplary components. The base portion 624 may, for example, be provided with grooves (“grooves” or “channels”) 627 that extend from each support stick hole 622. Each of the grooves 627 may hold each support stick 604. A support stick 604 may be slid into a groove 627 where the groove 627 meets the support stick hole 622, as shown by the location indicated by 627-a, for example. The shield assembly apparatus 621 may be secured shut by, for example, placing the top portion 623 onto the base portion 624, and securing the shield assembly apparatus 621 together with, for example, a screw 628 or any other suitable securing means. As an example, the securing of the top portion 623 to the base portion 624 may also securely hold the support sticks 604 in place. The support sticks 604 may be placed into the grooves 627 before assembly of the top portion 623 with the base portion 624, or alternatively, the top portion 623 and the base portion 624 may be loosely secured together, and next, the support sticks 604 may be inserted into the grooves 627, and next, the top portion 623 and the base portion 624 may be more securely tightened together.

As is also shown in FIG. 6D, the plurality of support sticks 604 held by the shield assembly apparatus 621 may extend radially around the shield assembly apparatus 621 due to the support stick holes 622 being in a circular arrangement. The support sticks 604 may thus form a platform support structure for the cover (not shown). The cover may then be held above and arranged around a plant, or may enclose a plant to be protected by the shield.

FIGS. 7A-7D show the top perspective view, the top plan view, the bottom plan view, and the side elevation view, respectively, of the base portion 724 of a shield assembly apparatus of FIG. 6A, according to an aspect. The floor 724-a of the base portion 724 may form the bottom of the interior space within a fully assembled shield assembly apparatus (as shown by 621 in FIG. 6A). Again, the base portion 724 may be provided with a plurality of support stick holes 722, and a plurality of grooves 727, with each groove 727 being associated with a support stick hole 722 such that a support stick (as shown by 604 in FIGS. 6B-6D) can be inserted into a support stick hole 722 and be secured within a groove 727. The center of the base portion may be provided with, again, a second center hole 731 for receiving a means for securing the base portion 724 with the top portion (as described when referring to FIG. 6D). The second center hole 731 may pass through the base portion 724. The bottom side of the base portion 724 may, again, be provided with a stem receiving tube 725, which may be aligned with the second center hole 731. That is, the second center hole 731 may extend through the base portion 724 and thus, the hollow portion of the stem receiving tube 725 may be in communication with the second center hole 731.

The grooves 727 may be radially disposed on the floor 724-a, throughout the interior space of the base portion 724, by having each groove 727 extend from a support stick hole 722 to the second center hole 731. The second center hole 731 may be raised from the floor 724-a of the interior space by being within a tube (“tube” “base center tube,” or “base tube”) 731-a extending from the floor 724-a. Each groove 727 may be sloped such that the portion of the groove 727 that meets the support stick hole 722, indicated by 727-a, is lower and closer to the floor 724-a than the portion of the groove 727 that meets the second center hole 731, indicated by 727-b. Thus, the walls 727-c on each side of each groove 727 may be taller towards the center of the base portion 724. Thus, the grooves 727 may be sloped downwards from the center to the outer edge 726 of the base portion 724. An advantage may be that the thicker walls 727-c at the center of the base portion 724 may provide durability, and a better reinforced grip or hold on the support sticks, as well as a reinforced or stronger support to the shield itself. Again, as an example, eight grooves 727 may be provided radially disposed within the base portion 724.

Again, the base portion 724 may be provided with a bottom stem portion 725, which may be used for receiving a stem (as shown by 203 in FIG. 2A) of a shield, for example. Thus, the shield assembly apparatus (as shown by 621 in FIG. 6A) may be used for securing together the stem and the support sticks of a shield into a shield assembly. Again, the holes 722 associated with grooves 727 may be disposed along an outer edge 726 of the base portion 724.

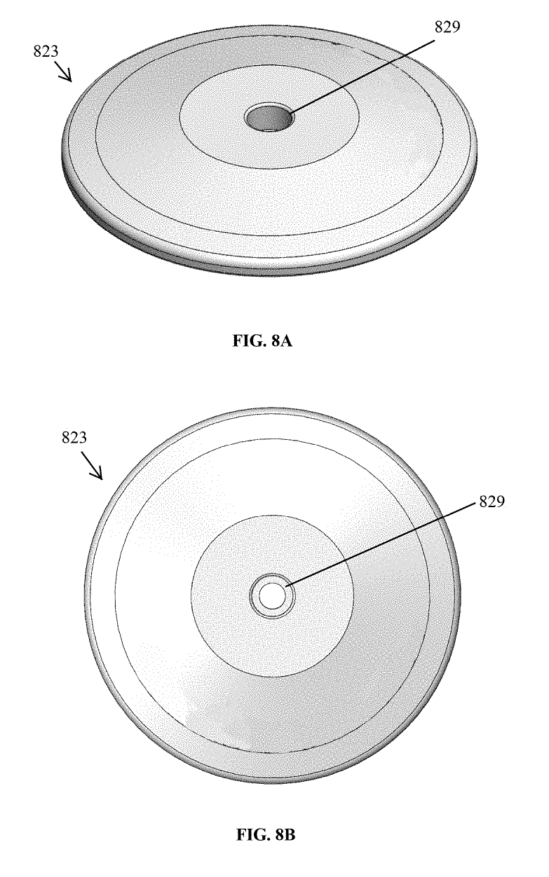

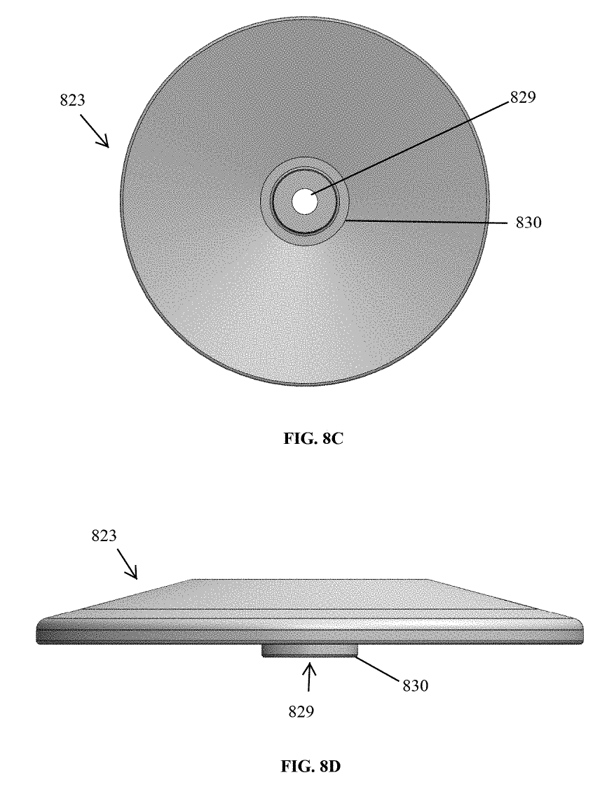

FIGS. 8A-8D show the top perspective view, the top plan view, the bottom plan view, and the side elevation view, respectively, of the top portion 823 of the shield assembly apparatus of FIG. 6A, according to an aspect. The top portion 823 may, again, be provided with a first center hole 829 at a center portion of the top portion 823, and may pass through the top portion 823, as an example. The first center hole 829 may be used for receiving a screw or any other suitable securing means (as shown by 628 in FIG. 6D) in order to secure the top portion 623 and the base portion (as shown by 724 in FIGS. 7A-D) together, for example.

As shown in FIG. 8C, the first center hole 829 may go through the entire top portion 823, for example. On the bottom side of the top portion 823, a securing stem 830 may be provided, which may correspond to and associate with the second center hole of the base portion (as shown by 731 in FIGS. 7A and 7B), in order to associate the top portion 823 with the base portion (as shown by 724 in FIGS. 7A-7D). As an example, the securing stem 830 may protrude outwards, around the first center hole 829 as shown in FIG. 8D. In this view, the first center hole 829 is not visible, while the location of which is indicated by 829.

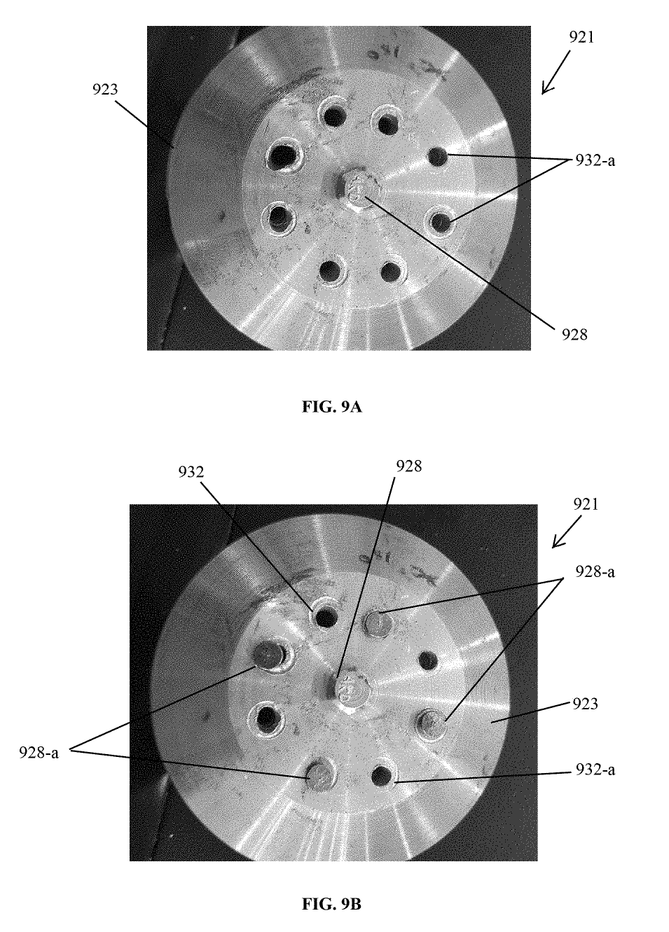

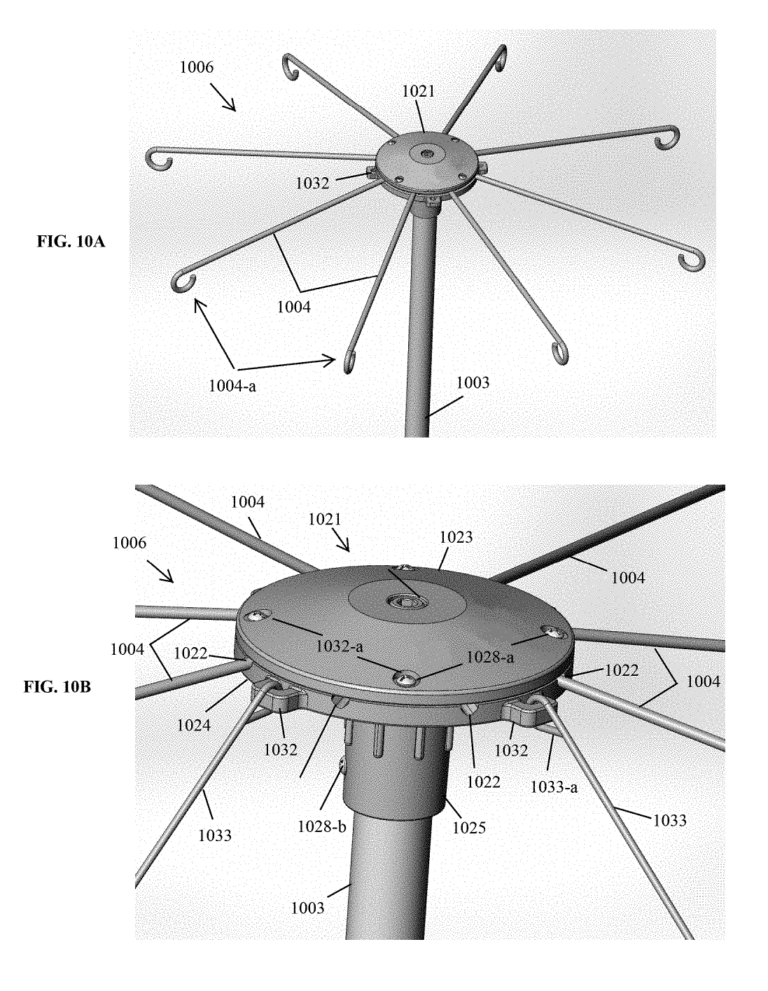

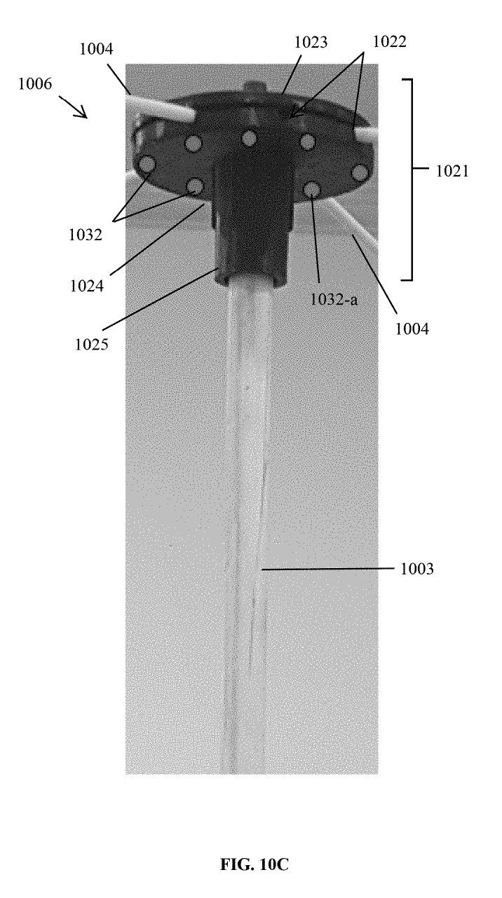

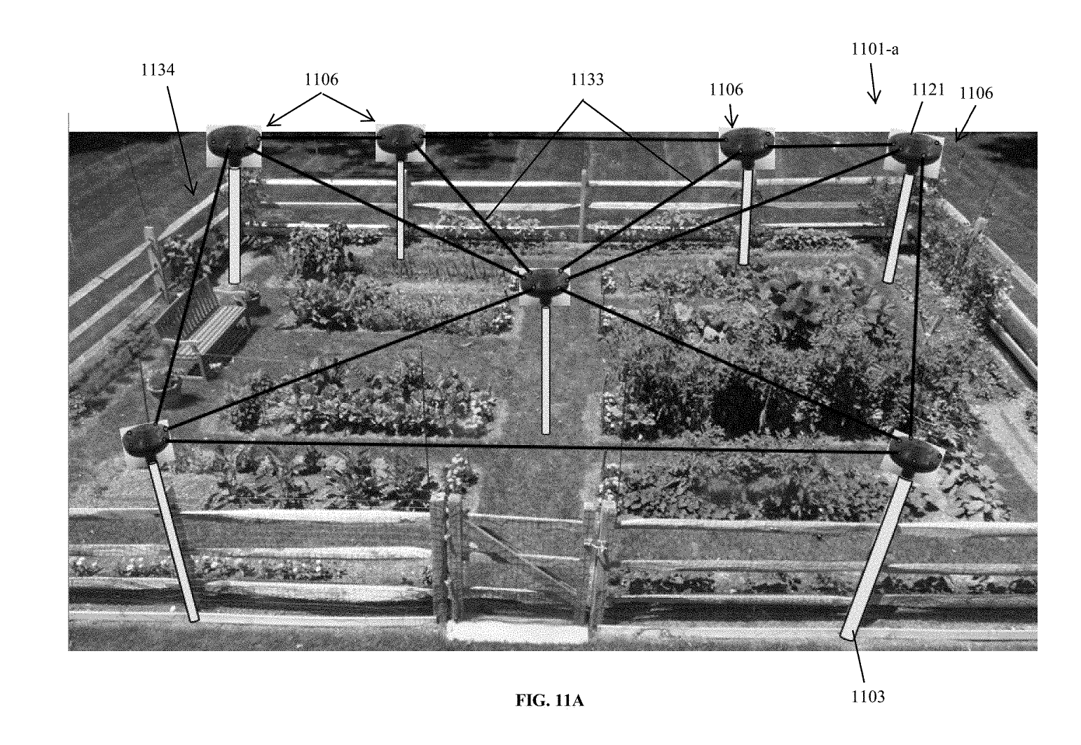

FIGS. 9A-9B show top perspective views of examples of an exemplary shield assembly apparatus 921 having apparatus holes 932-a, according to an aspect. An exemplary shield assembly apparatus 921 may be provided with apparatus holes 932-a in the top portion 923, which may be used for receiving wires (as will be further discussed when referring to FIGS. 10A-10B), or may also be used for receiving screws or other securing means. The screw 928 used for securing the shield assembly apparatus 921 together is also visible in this view. The apparatus holes 932-a may be used for receiving wire, but, again, may also be used for receiving additional screws, as shown by 928-a in FIG. 9B. An advantage may be that additional strength may be provided to the shield assembly apparatus 921, such as when longer or heavier support sticks are used with the shield assembly apparatus 921 for the construction of the shield, for example. Another advantage may be that the joining of the top portion (as shown by 623 in FIG. 6D) with the base portion (as shown by 624 in FIG. 6D) may be strengthened by the addition of the screws 928-a. Nuts may also be used together with the screws 925-a to strengthen the assembly of the shield assembly apparatus 921. The apparatus holes 932-a may be, for example, provided in any part of the top portion such as in the middle top portion as shown in FIGS. 9A-9B, or along the outer rim of the top portion 923 as another example.

FIGS. 10A-10B show the top perspective view and the front perspective view, respectively, of a frame 1006 with an exemplary shield assembly apparatus 1021 having wire loops (“wire holes” or “wire loops”) 1032, according to an aspect. Wire loops 1032 may be provided in the shield assembly apparatus 1021, and are shown in an empty state in FIG. 10A for visual clarity. The wire loops 1032 are shown holding wires 1033 in FIG. 10B. The wire loops 1032 may be used for receiving wires 1033. As shown, the wire loops 1032 may extend outwards from the outer edge 1026 of the shield assembly apparatus 1021, and may be disposed in between the support stick holes 1022. After a wire 1033 is threaded through a wire loop 1032, the wire 1033 may be bent or tied into an appropriate shape such that the wire 1033 is secured to the wire loop 1032, for example. The wires 1033 may, for example, be bendable or flexible and may be configured to hold their shape after being bent into a suitable or desired shape. As shown as an example, the wires 1033 may be bent into a hook 1033-a. The wires 1033 may be used for connecting a plurality of shield assembly apparatuses 1021 together. This may be performed in order to construct a large or custom-sized shield according to the user's needs, for example. Each shield assembly apparatus 1021 can then support a portion of the shield's cover, and the shield may be used for protecting a large area of crops or plants. Each shield assembly apparatus 1021 can also be fitted with a stem, of which a partial view is shown by 1003. As an example, the stem receiving tube 1025 of the shield assembly apparatus 1021 may receive the stem 1003 of the shield. As an example, an additional screw 1028-b may be used for securing the stem 1003 into the stem receiving tube 1025. Next, the support sticks (as partially shown by 1004 in FIG. 10B) may be inserted into the support stick holes 1022, such that the support sticks (as shown by 204 in FIG. 2A) can support and hold up a cover (as shown by 411 in FIG. 4). The wires 1033 may run through the top portion 1023 alone, or may run from top to bottom or vice versa. The wires 1033 may thus be inserted through wire loops 1032 of either or both the top portion 1023 and the base portion 1024. As an example, a plurality of wire loops 1032 may be provided, and the shield assembly apparatus 1021 may have eight wire loops 1032 in the top portion 1023 and eight wire loops in the base portion 1024. Apparatus holes 1032-a having screws 1028-a are also visible in FIG. 10B.

As an example, a plurality of eight support stick holes 1022 may be provided, and all or only a portion of the support stick holes 1022 may be fitted with support sticks 1004, according to the user's needs. The front support stick holes 1022 are shown in an empty state for visual clarity in FIG. 10B, while the remaining support stick holes 1022 are fitted with support sticks 1004. As an example, the support sticks 1004 may be curved at their distal ends 1004-a. An advantage may be that the curved or rounded end may help to prevent the support sticks 1004 from becoming caught in netting or foliage. Again, the support sticks 1004 may be rigid to help hold or support a cover or net, while the wires 1033 may be bendable and flexible while also being configured to hold their shape after being bent. As an example, four wire loops 1032 may be provided in a shield assembly apparatus 1021 (with only three wire loops visible in the views shown in FIGS. 10A-10B, the fourth wire loop being on the rear side).

FIG. 10C shows the bottom perspective view of a frame 1006 with an exemplary shield assembly apparatus 1021, according to an aspect. As is shown as an example, apparatus holes 1032-a may also be provided on the bottom of the assembly apparatus 1021, which, again, may receive wires or screws or any other securing means. Again in this view, a support stick hole 1022 at the front of the view is shown in an empty state for visual clarity, and remaining support stick holes 1022 are shown with support sticks 1004.

Together, the shield assembly apparatus 1021, support sticks 1004, and stem 1003 may comprise the frame 1006 of the shield, and the frame 1006 may support a cover, as shown by 411 in FIG. 4. It should be understood that the frame 1006 as shown in FIG. 10B may be used with or without a post as shown by 509 in FIGS. 5A-5C, for example, for the construction of a shield for protecting plants.

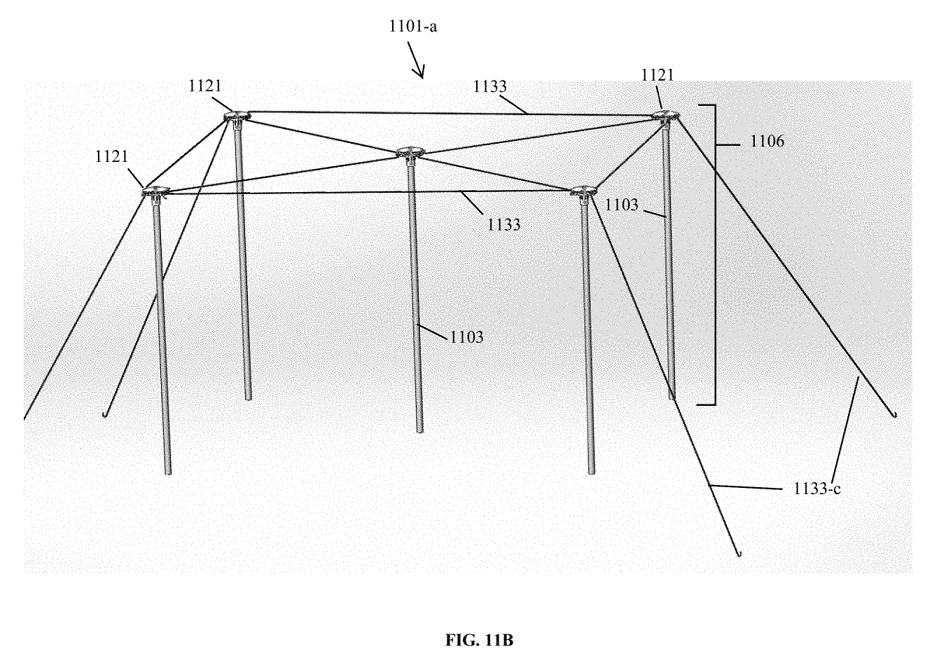

FIGS. 11A-11B show the top perspective views of a shield system 1101-a in a garden 1134, and a shield system 1101-a alone, respectively, according to an aspect. The shield system 1101-a may be comprised of a plurality of shields 1101. For visual clarity, the shield system 1101-a is shown without a cover. It should be understood that a cover may be used with the shield system 1101-a or a plurality of covers may be combined together to be used with the shield system 1101-a. Thus, a canopy may be created for the garden 1134. A shield system 1101-a may be created by combining a plurality of frames 1106, wherein each frame 1106 is provided with a stem 1103, and a shield assembly apparatus 1121. Each shield assembly apparatus 1121 may be provided with wire loops (as shown in detail in by 1032 in FIG. 10B), such that the shields 101 may be connected together using wires 1133. The wires 1133 may connect the shields 101 together by being threaded through the wire loops (as shown by 1032 in FIG. 10B) of all of the shields 101 within the shield system 1101-a. As shown, each stem 1103 may be inserted into the ground, and the height of each stem 1103 may be tall enough such that the cover, when in use, does not rest on the plants being protected.

As is shown as an example in FIG. 11, the shield system 1101-a may be used with the wires 1133 supporting a cover (not shown). As another example, the shield system 1101-a may also be used with support sticks (as is shown in FIG. 10B).

As another example, some wires may also be used for securing the shield system 1101-a to the ground, such as by using the wires indicated by 1133-a and securing them to the ground. These wires 1133-c may be similar to the wires 1133 or the same type of wires may be used. The securement of the wires 1133-c to the ground may also be used for balancing the shield system 1101-a on the ground.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. A shield for protecting a plant, the shield comprising:
a shield assembly apparatus having:
a top apparatus portion having an upper top apparatus portion end, a bottom top apparatus portion end, and a first center hole passing through the top apparatus portion;
a base apparatus portion configured to be associated with the top apparatus portion, the base apparatus portion having a floor, an upper base apparatus portion end, a bottom base apparatus portion end, a base center tube extending upwards from the floor, a second center hole passing through the base center tube and through the base apparatus portion;
an interior space formed by an association of the top apparatus portion with the base apparatus portion;
an outer edge having a rounded shape;
a plurality of support stick holes in a circular arrangement along the outer edge;
a plurality of grooves within the interior space;
wherein each groove of the plurality of grooves is supported by walls extending upwards from the floor;
wherein each groove of the plurality of grooves extends from a support stick hole of the plurality of support stick holes to the base center tube;
wherein each groove of the plurality of grooves is sloped such that the walls are taller when meeting the base center tube than when meeting a support stick hole of the plurality of support stick holes;
such that the shield assembly apparatus is capable of supporting frame components within the plurality of grooves; and
wherein the shield is capable of shielding and protecting the plant without any portion of the shield being supported by the plant.

2. The shield of claim 1, wherein the association of the top apparatus portion with the base apparatus portion causes the first center hole and the second center hole to be aligned;
such that a securing means can be inserted through both the first center hole and the second center hole to secure the top shield assembly apparatus portion and the base shield assembly apparatus portion together; and
wherein the securing means is capable of adjusting a space between the top shield assembly apparatus portion and the base shield assembly apparatus portion via a tightening or a loosening of the securing means;
such that a size of the plurality of support stick holes is adjustable.

3. The shield of claim 1, further comprising a first plurality of wire loops in the shield assembly apparatus; and a plurality of wires capable of being threaded through the first plurality of wire loops.

4. The shield of claim 3, further comprising a second shield having a second plurality of wire loops in a second shield assembly apparatus;
wherein the plurality of wires is capable of being threaded through the first plurality of wire loops and threaded through the second plurality of wire loops;
such that the shield is connected to the second shield;
such that a shield system having a plurality of shields is assembled.

5. The shield of claim 3, wherein each wire loop of the first plurality of wire loops is capable of receiving a securing means such that the association of top shield assembly apparatus portion with the base shield assembly apparatus portion is strengthened.

6. The shield of claim 1, further comprising a post having:
a hollow shaft;
an upper post end being capable of removably receiving the stem by insertion of the bottom stem end into the hollow shaft; and
a lower post end having a point configured to be driven into soil.

7. The shield of claim 1, the base apparatus portion further comprising a stem receiving tube on the bottom base apparatus portion end.

8. The shield of claim 1, wherein the frame components comprise a plurality of support sticks;
wherein each support stick of the plurality of support sticks can be inserted into the support stick hole of the plurality of support stick holes, and next inserted into and held in place by a groove of the plurality of grooves.

9. A shield for protecting a plant, the shield comprising:
a frame, and a cover supported by the frame; the frame having:
a stem having an upper stem end and a bottom stem end;
a plurality of support sticks; and
a shield assembly apparatus having:
a top apparatus portion having an upper top apparatus portion end, a bottom top apparatus portion end, and a first center hole passing through the top apparatus portion;
a base apparatus portion configured to be associated with the top apparatus portion, the base apparatus portion having a floor, an upper base apparatus portion end, a bottom base apparatus portion end, a base center tube extending upwards from the floor, a second center hole passing through the base center tube and through the base apparatus portion, and a stem receiving tube on the bottom base apparatus portion end configured to receive the upper stem end;
an interior space formed by an association of the top apparatus portion with the base apparatus portion;
an outer edge having a rounded shape;
a plurality of support stick holes in a circular arrangement along the outer edge;
a plurality of grooves within the interior space;
wherein each groove of the plurality of grooves is supported by walls extending upwards from the floor;
wherein each groove of the plurality of grooves extends from a support stick hole of the plurality of support stick holes to the base center tube;
wherein each groove of the plurality of grooves is sloped such that the walls are taller when meeting the base center tube than when meeting a support stick hole of the plurality of support stick holes;
wherein each support stick of the plurality of support sticks can be inserted into the support stick hole of the plurality of support stick holes, and next inserted into and held in place by a groove of the plurality of grooves;
wherein the shield assembly apparatus is capable of supporting the plurality of support sticks within the plurality of grooves such that the plurality of support sticks forms a platform support structure for the cover in which the entire first plurality of sticks or a portion thereof extends in a circular arrangement above the plant; and
wherein the shield is capable of shielding and protecting the plant without any portion of the shield being supported by the plant.

10. The shield of claim 9, wherein the association of the top apparatus portion with the base apparatus portion causes the first center hole and the second center hole to be aligned;
such that a securing means can be inserted through both the first center hole and the second center hole to secure the top shield assembly apparatus portion and the base shield assembly apparatus portion together; and
wherein the securing means is capable of adjusting a space between the top shield assembly apparatus portion and the base shield assembly apparatus portion via a tightening or a loosening of the securing means;
such that a size of the plurality of support stick holes is adjustable.

11. The shield of claim 9, further comprising a first plurality of wire loops in the shield assembly apparatus; and a plurality of wires capable of being threaded through the first plurality of wire loops.

12. The shield of claim 11, further comprising a second shield having a second plurality of wire loops in a second shield assembly apparatus;
wherein the plurality of wires is capable of being threaded through the first plurality of wire loops and threaded through the second plurality of wire loops;
such that the shield is connected to the second shield;
such that a shield system having a plurality of shields is assembled.

13. The shield of claim 11, wherein each wire loop of the first plurality of wire loops is capable of receiving a securing means such that the association of top shield assembly apparatus portion with the base shield assembly apparatus portion is strengthened.

14. The shield of claim 9, further comprising a post having:
a hollow shaft;
an upper post end being capable of removably receiving the stem by insertion of the bottom stem end into the hollow shaft; and
a lower post end having a point configured to be driven into soil.

15. A method of providing protection to a plant using a shield comprising: a frame, and a cover supported by the frame; the frame having:
a stem having an upper stem end and a bottom stem end;
a plurality of support sticks; and
a shield assembly apparatus configured to be associated with the stem by having a hollow tube for receiving the upper stem end; the shield assembly apparatus having:
a top apparatus portion having an upper top apparatus portion end, a bottom top apparatus portion end, and a first center hole passing through the top apparatus portion;
a base apparatus portion configured to be associated with the top apparatus portion, the base apparatus portion having a floor, an upper base apparatus portion end, a bottom base apparatus portion end, a base center tube extending upwards from the floor, a second center hole passing through the base center tube and through the base apparatus portion, and a stem receiving tube on the bottom base apparatus portion end;
an interior space formed by an association of the top apparatus portion with the base apparatus portion;
an outer edge having a rounded shape;
a plurality of support stick holes in a circular arrangement along the outer edge;
a plurality of grooves within the interior space;
wherein each groove of the plurality of grooves is supported by walls extending upwards from the floor;
wherein each groove of the plurality of grooves extends from a support stick hole of the plurality of support stick holes to the base center tube;
wherein each groove of the plurality of grooves is sloped such that the walls are taller when meeting the base center tube than when meeting a support stick hole of the plurality of support stick holes;
wherein each support stick of the plurality of support sticks can be inserted into the support stick hole of the plurality of support stick holes, and next inserted into and held in place by a groove of the plurality of grooves;
wherein the shield assembly apparatus is capable of supporting the plurality of support sticks within the plurality of grooves such that the plurality of support sticks forms a platform support structure for the cover in which the entire first plurality of sticks or a portion thereof extends in a circular arrangement above the plant; and
wherein the shield is capable of shielding and protecting the plant without any portion of the shield being supported by the plant;
the method comprising the steps of:
providing the shield assembly apparatus in a disassembled state;
creating the frame by inserting each support stick of the plurality of support sticks into each support stick hole of the plurality of support stick holes;
securing each support stick of the plurality of support sticks by inserting each support stick into each groove of the plurality of grooves;
securing the top shield assembly apparatus portion to the base shield assembly apparatus portion to provide the shield assembly apparatus in an assembled state;
associating the stem with the shield assembly apparatus by inserting the top stem end into the stem receiving tube;
anchoring the bottom stem end around the plant;
placing the cover on top of the platform support structure;
removing the cover when a user determines the protection is not needed, while the frame remains in the soil; and
replacing the cover when the user determines the protection is needed.

16. The method of claim 15, the shield further comprising:
a first plurality of wire loops in the shield assembly apparatus;
a second shield having a second plurality of wire loops in a second shield assembly apparatus;
a plurality of wires capable of being threaded through the first plurality of wire loops and threaded through the second plurality of wire loops;
such that the shield is connected to the second shield; and
such that a shield system having a plurality of shields is assembled;
the method further comprising the steps of:
threading the plurality of wires through the first plurality of wires holes;
connecting the shield to the second shield by threading the plurality of wires through the second plurality of wires holes; and
assembling the shield system.

17. The method of claim 16, further comprising the step of:
supporting a cover on top of the shield system.

18. The method of claim 15, wherein the association of the top apparatus portion with the base apparatus portion causes the first center hole and the second center hole to be aligned;
such that a securing means can be inserted through both the first center hole and the second center hole to secure the top shield assembly apparatus portion and the base shield assembly apparatus portion together; and
wherein the securing means is capable of adjusting a space between the top shield assembly apparatus portion and the base shield assembly apparatus portion via a tightening or a loosening of the securing means;
such that a size of the plurality of support stick holes is adjustable;
the method further comprising the steps of:
providing the plurality of support sticks;
determining the size of the plurality of support stick holes needed to fit the plurality of support sticks into the shield assembly apparatus; and
tightening the securing means if the plurality of support stick holes is needed to be smaller, or loosening the securing means if the plurality of support stick holes is needed to be larger.

19. The method of claim 16, further comprising the steps of:
providing the plurality of shields; and
repeating the threading, connecting, and assembling steps to enlarge the shield system.

20. The method of claim 15, the shield further comprising a post having:
a hollow shaft;
an upper post end being capable of removably receiving the stem by insertion of the bottom stem end into the hollow shaft; and
a lower post end having a point configured to be driven into soil;
wherein the anchoring step comprises inserting the bottom stem end into the upper post end; and driving the lower post end into the soil.
